(19) United States
(12) Patent Application Publication
(10) Pub. No.: US 2007/0182312 A1
(43) Pub. Date: Aug. 9, 2007

(54) DIODE ELEMENT AND DISPLAY APPARATUS USING SAME AS ELECTRON SOURCE

(76) Inventors: Masakazu Sagawa, Inagi (JP); Tatsumi Hirano, Hitachinaka (JP); Hideyuki Shintani, Mobara (JP); Ken Okutani, Tachikawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/672,601

(22) Filed: Feb. 8, 2007

(30) Foreign Application Priority Data
Feb. 8, 2006 (JP) 2006-030707

(51) Int. Cl. H01J 63/04; H01J 1/62

(52) U.S. Cl. 313/495

(57) ABSTRACT

In order too control the non-uniformity of electron emission amount within the surface or between adjacent pixels which is a cause for formation non-uniformity when forming, using anodization, an electron acceleration layer for an MIM type diode element which is appropriate for a thin film electron source, there is provided an insulation layer 12 which forms a MIM type diode element as a non-crystalline oxidized film which is formed by anodization of the surface of a lower electrode 11 with the formation of the lower electrode 11 as laminated layers which have a single layer film of aluminum or aluminum alloy or an outer layer of any of these, with a non-phosphor as a single layer film of aluminum or aluminum alloy which is anodized.

### CLAIM OF PRIORITY

The present application claims priority from Japanese application JP 2006-030707 filed on Feb. 8, 2006, the content of which is hereby incorporated by reference into this application.

### FIELD OF THE INVENTION

This invention relates to a diode element of the metal-insulation layer-metal type, and especially to a diode element appropriate for a thin film type electron source for an image display apparatus of flat panel system which displays an image by making striking a fluorescence surface using electrons which are released from a plurality of electron sources which are arranged in matrix form and a display apparatus with a diode element as an electron source.

### BACKGROUND OF THE INVENTION

With devices that display images using thin film electron source (called electron release elements, emitters or cathodes) arrays that can be miniaturized and integrated, and especially by making display apparatus that are abbreviated as flat panel displays (FPD), there are image display apparatus which use thin film type electron sources such as metal-insulator-metal (MIM) type, metal-insulator-semiconductor (MIS) type, surface conduction type or metal-insulator-semiconductor-metal type. Here, there is an explanation of one example of diode elements which form an MIM type thin film electron source array and a display apparatus which uses these diode elements. Moreover, the thin film electron source array is termed a thin film electron source or simply an electron source. In addition, a display apparatus of this kind of flat panel display system is termed a panel. There is provided a Japanese patent JP-A No. 2004-111053 that discloses conventional technology which is related to this kind of display apparatus. In addition, Kusu et al. “Display Monthly” March, 2002 Techno Times Publisher, Vol. 8 No. 3, p. 54 (2002) gives an explanation of the operating principles and construction of an MIM electron release element.

FIG. 20 is a cross-sectional view which explains one example of the fundamental construction of thin film electron sources used as MIM diode elements. FIG. 21 is a diagram which explains the operating principles of FIG. 20's diode elements. The MIM thin film electron source has an integrated upper electrode 13 through crossing of the tunnel insulating layer (called electron acceleration layer) 12 and the interlayer insulating layer 14 to the bottom electrode 11 that forms a film on the insulating substrate 10. The upper electrode 13 is power supplied by the upper electrode power supply interconnection 16 and the connection electrode 15. A surface protective layer 17 is formed on top of the upper electrode power supply line interconnection 16 and a thin film 13′ is formed for upper electrode formation on top of the protective layer.

First, there is an explanation of the operating principles of the thin film electron source shown in FIG. 20 using FIG. 21. In FIG. 21, there is impressed a dynamic voltage Vd between the upper electrode 13 and the bottom electrode 11, and when the electric field within the tunnel insulating layer 12 which is the electron acceleration layer is made to the range of 1-10 MV/cm, electrons within the vicinity of the Fermi level within the bottom electrode 11 penetrate the barrier and are injected into the conduction band of the tunnel insulating layer 12 and the upper electrode 13, becoming hot electrons.

These hot electrons lack the energy to be distributed within the tunnel insulating layer 12 and the upper electrode 13, but one portion of the hot electrons which have energy in excess of the work function Φ of the upper electrode are released into the vacuum 20. There are other thin film electron sources with operating principles that are somewhat different, but have the common feature that there is a release of hot electrons by passing through the thin upper electrode 13.

As shown by the cross-sectional construction in FIG. 20, with the bottom electrode 11 composed of diode elements which form this kind of thin film electron source and the upper electrode 13 which intersects with this bottom electrode 11, and an upper electrode power supply wire interconnection 16 which supplies power to this upper electrode, there is an electrode source array through arrangement in the form of a 2-D matrix. By applying a display signal on the bottom electrode and a scan signal on the upper electrode (upper electrode power supply interconnection 16), an image is displayed by positioning on a fluorescent body electrons from the thin film electron source of the intersecting part. Moreover, in this case, the upper electrode power supply interconnection 16 becomes the scan line bus interconnection.

The tunnel insulating layer which is the electron acceleration layer is formed by an oxidized layer by anode oxidation of underlying metals (aluminum (Al)) which acts as the bottom electrode or aluminum alloys (alloys of aluminum and, for example, neodymium (Nd) or metal tantalum (Ta)).

Non-patent document 2: Schultze et al. Corrosion Engineering, Science and Technology Vol. 39 No. 1 p. 45 (2004) Schultze et al. Corrosion Engineering, Science and Technology Vol. 39 No. 1 p. 45 (2004)

### SUMMARY OF THE INVENTION

When forming the insulating layer with an oxidized film by oxidizing the underlying metal, generally, thermal oxidation is used. In this case, the properties of film thickness, boundary state, and fixed charge are known to depend on the underlying crystalline state as well as on the thermal processing conditions. Also, with anode oxidation which is an electrochemical oxidation method, it has been reported in Kusu et al. “Display Monthly” March, 2002 Techno Times Publisher, Vol. 8 No. 3, p. 54 (2002) that the same phenomenon occurs. In addition, Japanese Patent JP-A No. 1996-31302 discloses an example of forming a MIM emitter through anode oxidation of the metal tantalum (Ta). In the Document, it is disclosed that by making the underlying metal tantalum (Ta) film amorphous, (1) diode current decreases and (2) at the same time, emitter current increased. The reason for these effects is that a grain boundary exists in multi-crystal metals, and oxidized film defects on the grain boundary become generating sources for leak currents. Because of leak currents, with amorphous substances, there is no effect on the grain boundary, nor impact on emission, so that leak currents are reduced. In addition, at the same time, because the stability of the oxidized film improves, there is also an explanation for the increase in emission current.

Because of the improvements listed above, this invention adopted MIM emitters which use Al alloys. The inventors, considering the previously described Documents, discovered differing phenomena when performing the same experiments. FIG. 1 is a diagram showing, for the underlying film, the emission current in a MIM emitter which is composed of respectively a non-oriented multi-crystal film and (111) an oriented multi-crystal film, with the diode voltage dependencies for the diode currents. FIG. 1, for a MIM emitter which is respectively comprised of a non-oriented multi-crystal film, hereinafter a non-oriented film (following B film), and (111) an oriented multi-crystal film, hereinafter an oriented film (following A film) on the lower film, shows the diode voltage dependencies of the emission current and the diode current.

As shown in FIG. 1, (1) the MIM emitter which is composed of the previously cited Ta differs with small diode leak current and precise threshold properties. No difference is seen in the two construction for the leak current as diode current. The threshold value is off by 0.5V to the right for an oriented film. (4) Considering the difference in threshold values, the emission currents and electron practical efficiencies are the same.

In this way, the Ta oxidized film shows different electrical properties and as the electrical conduction of the Ta oxidized film occurs as a P-F (Poole-Frenkel) conduction, though with the Al oxidized film, there is thought to be an F-N (Fowler-Nordheim) conduction. Consequently, it is necessary, in explaining the electrical properties from the differences in orientation, to discover distinct reasons for the influence of the grain boundaries.

The reasons, for the previously described (2)-(4) phenomenon, can be thought of being equally explained by that the oxidized film thickness of the A (111) oriented film is thick compared to the non-oriented one and that the positive fixed charge within the oxidized film for the B (111) oriented film is small, though assigning causes at the present time is difficult.

By way of experiment, when making the so-called F-N plot of the diode current-voltage, J/E² and 1/E approximate a straight line. From the slope and intercept of the lines, the barrier height and effect mass of the electron are obtained. At this time, using hypothesis A, assume that the film thickness of the oriented film is 5%, then the following table results with good results repeatability.

| | | | Electron |
|---|---|---|---|
| | | | effective mass |
| | Film thickness | Barrie height | ratio |
| A film (111) | 11.1 nm | 2.18 eV | 0.52 |
| oriented | | | |
| B film (low | 10.6 nm | 2.09 eV | 0.59 |
| orientation) | | | |

Be that as it may, it cannot be said that it is acceptable for the electrical properties of the elements to be affected by the crystalline nature of the underlying film. There must be appropriate control during the manufacturing process of crystal orientation.

The goal of this invention is to control the non-uniformity of distribution of the electron release amount within the surface or between adjacent pixels which is attributed to film formation uniformities when forming using anode oxidation the electron acceleration layer of appropriate MIM type diode elements by a thin film electron source. In addition, the invention is to provide diode elements for which brightness differences within the surface may be reduced when used with a display apparatus and to provide a display apparatus with these diode elements as an electron source.

In order to achieve the previously described goals, this invention, assuming that the [I] non-oriented film is the lower electrode composed of underlying metal for forming the electron acceleration layer or that the [II] low orientation film is used in the same way, controls the orientation distribution within the substrate. The fundamental formation is assumed to be as described. The following is a representative construction for this invention.

The diode element of this invention forms a diode element of metal-insulating layer-metal type by stacking in order a lower electrode which is formed on a flat substrate, an insulating layer, and an upper electrode.

The previously described insulating layer is composed of a non-crystalline oxidized film which formed by anode oxidation processing a surface of the previously described lower electrode, the previously described lower electrode is composed of a single layer film of aluminum or aluminum alloy or a laminated film which has an outermost layer of one of these materials. In addition, the previously described aluminum or aluminum alloy film is amorphous for a process for the previously described anode oxidization.

In addition, the invention is composed of an amorphous oxidized film that forms, using anode oxidation processing, a surface for the previously described lower electrode and the previously described lower electrode is composed of a single layer film of aluminum or aluminum alloy or a laminated film which has an outermost layer of one of these materials. In addition, in a process of the previously described anode oxidation, with wide-angle X-ray diffraction from the previously described aluminum or aluminum alloy film, the ratio of the peak strength (220) diffraction line and the peak strength (111) diffraction line has a range from 0.2 to 0.6 for crystals of low oriented aluminum or aluminum metal alloys.

In addition, this invention is composed of amorphous oxidized film that forms, using anode oxidation processing, a surface for the previously described lower electrode and the previously described lower electrode is composed of a single layer film of aluminum or aluminum alloy or a laminated film which has an outermost layer of one of these materials. When practically used, the previously described aluminum or aluminum alloy film is characterized by a half-width distribution for the X-ray diffraction rocking curve of a superior oriented crystal surface within the previously described substrate of 10% or less.

In addition, the invention's diode element, with respect to this previously described lower electrode, injects in the previously described insulating film hot electrons by applying a positive bias to the previously described upper electrode, forming a cold cathode electron source that releases towards the vacuum from the previously described upper electrode one part of said injected hot electrons. The previously described upper electrode has a film thickness that is the same or less than when compared to the average free process related to electron scattering within said electrode. In addition, the surface work function is small compared to the maximum energy of the hot electrons within said electrode.

In addition, the previously described upper electrode from the previously described diode elements is characterized by having a laminated film which has superimposed in order iridium, platinum, and gold.

The display apparatus of this invention has a flat first substrate which provides on the inner surface a plurality of electron sources which are arranged like a matrix and a flat second substrate which provides a plurality of phosphors which are arranged respectively for the previously described electron sources. Finally, the display uses diode elements as electron sources with the previously described construction.

This invention is not limited to the construction previously described or embodiment later described.

The effect of the invention is to control the non-uniformity of distribution of the electron release amount within the surface or between adjacent pixels which is attributed to film formation uniformities when forming using anode oxidation the electron acceleration layer of appropriate MIM type diode elements by a thin film electron source.

### BRIEF DESCRIPTION OF THE DRAWINGS

FIG. 1 shows the diode voltage dependency of the emitter current and diode current for a MIM emitter which is respectively comprised of a non-oriented multi crystalline film and a (111) oriented multi crystalline film on a seed film;

FIG. 2 explains the relationship of the diffraction angle and diffraction strength for every kind of aluminum-neodymium film shown using wide-angle X-ray diffraction;

FIG. 3 shows (a) a front light display photo of a display surface for a cathode substrate, the results (b) of measurement using AFM of the surface roughness distribution of the tunnel part, and (c) measured results using a probe type step meter for the same distribution;

FIG. 4 is a diagram which shows (a) the measured results using AFM of the surface roughness of the tunnel part of the Al—Ni film which was manufactured under the same conditions as the cathode substrate used in FIG. 3, and (b) the measured results of the distribution of absolute reflectance for the same sites, and (c) the measured results of the distribution for sheet resistance at the same sites;

FIG. 5 is a diagram which shows the (a) measured results for the absolute reflectance of the Al—Nd film that was formed under the same conditions as the cathode electrode used in FIG. 3 and the (b) diffraction strength, (c) half-width, and (d) surface gap that was obtained from the rocking curve of the (111) diffraction peak using the same sites as the measurement sites as (a);

FIG. 6 explains the manufacturing process for the thin film type electron source of this invention;

FIG. 7 is a continuation diagram from FIG. 6 which explains the manufacturing process for the thin film type electron source of this invention;

FIG. 8 is a continuation diagram from FIG. 7 which explains the manufacturing process for the thin film type electron source of this invention;

FIG. 9 is a continuation diagram from FIG. 8 which explains the manufacturing process for the thin film type electron source of this invention;

FIG. 10 is a continuation diagram from FIG. 9 which explains the manufacturing process for the thin film type electron source of this invention;

FIG. 11 is a continuation diagram from FIG. 10 which explains the manufacturing process for the thin film type electron source of this invention;

FIG. 12 is a continuation diagram from FIG. 11 which explains the manufacturing process for the thin film type electron source of this invention;

FIG. 13 is a continuation diagram from FIG. 12 which explains the manufacturing process for the thin film type electron source of this invention;

FIG. 14 is a continuation diagram from FIG. 13 which explains the manufacturing process for the thin film type electron source of this invention;

FIG. 15 is a continuation diagram from FIG. 14 which explains the manufacturing process for the thin film type electron source of this invention;

FIG. 16 explains a construction example for a MIM type cathode substrate;

FIG. 17 explains a construction example for an anode substrate;

FIG. 18 is a cross-sectional view of an image display apparatus that has combined a cathode substrate and an anode substrate;

FIG. 19 is a development schematic which explains a summary of all construction examples for this invention's image display apparatus;

FIG. 20 is a cross-sectional view which, using the MIM type, explains a fundamental construction example for a thin film electron source; and

FIG. 21 explains the operation principles for a thin film electron source.

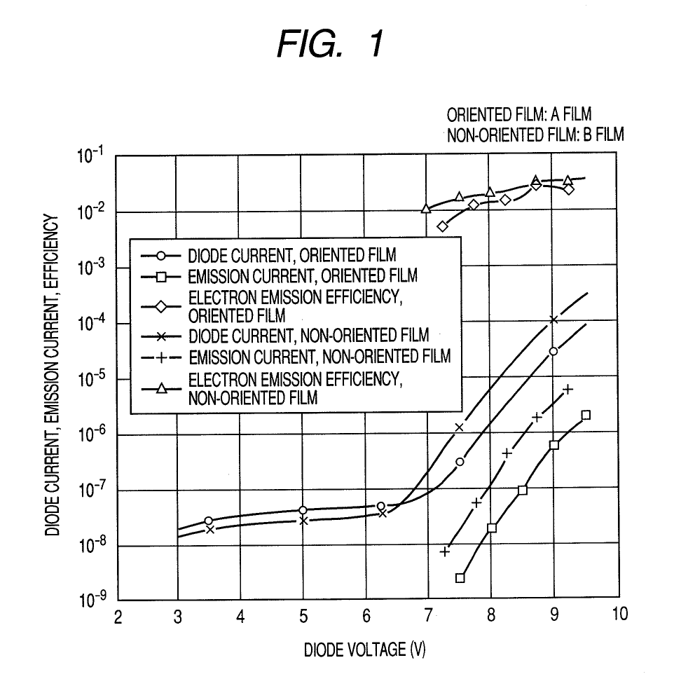

### DETAILED DESCRIPTION OF THE PREFERRED EMBODIMENTS

Below, there is a detailed explanation through drawings reference of the best embodiment of this invention.

### Embodiment 1

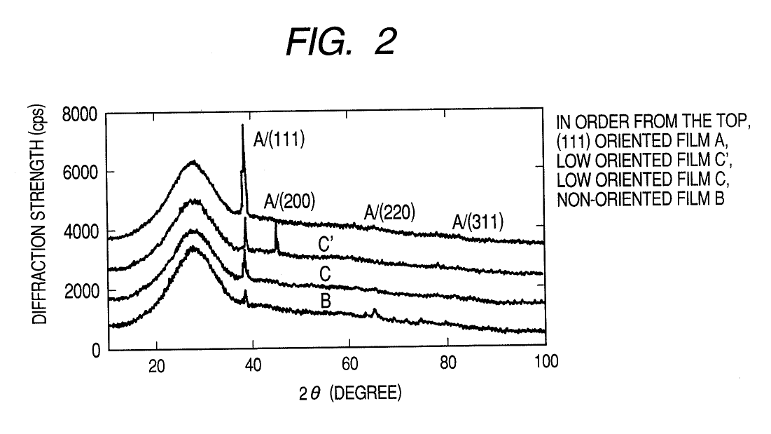

In Embodiment 1, there is disclosed the different characteristics of the MIM emitters that ware formed by the diode elements constructed from low oriented films with different degrees of orientation. FIG. 2 is a diagram which explains of the diffraction angle and diffraction strength of every kind of aluminum-neodymium shown by using wide-angle X-ray diffraction spectrums. Based on FIG. 2, there follows a definition of orientation degree which shows standards of strong and weak orientation.

Orientation degree=(220) strength/(111) strength

### When calculating the degree of orientation, with respect to each working film,

Non-oriented film: 0.035, 0.06, oriented film: 0.55, JCPDS card: 0.22

From these figures, the orientation degree for a low oriented film is assumed to be from 0.2 to 0.6. Use the following films A-C for forming Al alloy films.

(1) (111) oriented formed film (A film): use inline-type DC magnetron sputter. The inline-type DC magnetron sputter device uses strip fixed targets and forms films using a substrate that first passes through at a constant speed. Because this device has a load-lock structure and an oil-free discharge system, the base pressure is 10⁻⁷ Torr, resulting in a high vacuum. Using this kind of device, the film which is obtained under high film forming rates has ordinary (111) orientation.
(2) Low oriented film formation: for the A film of (1) there is used an RF magnetron sputter device (B film) which has an oil diffusion pump with no load-lock structure and a DC magnetron sputter device (C film) which has an oil-free discharge system. Using these kinds of devices, the film that is obtained a low formation film rates becomes a non-oriented film because of the participation within the chamber of remaining gases (water, hydrocarbons) or process gases (Ar).

In order to evaluate the crystal orientation nature of the respective previously described films, there is obtained wide-angle X-ray diffraction spectrums. The results are shown in FIG. 2. With A film, instead of the (111) diffraction line, the diffraction peaks of (220) and the like are observed. With respect to these measurements, only weak diffraction peaks are seen.

### Embodiment 2

In Embodiment 2, there is an explanation of when there is orientation distribution within the substrate. The previous in-line type DC magnetron sputter device is used to form an Al alloy. This sputter device is equipped with a action at a distance magnet for targets and there is prevention of the generation of a region where the sputter phenomenon, termed so-called erosion from the action at a distance, is concentrated. However, it was determined that an approximately 10% brightness distribution was generated within the substrate by this action at a distance.

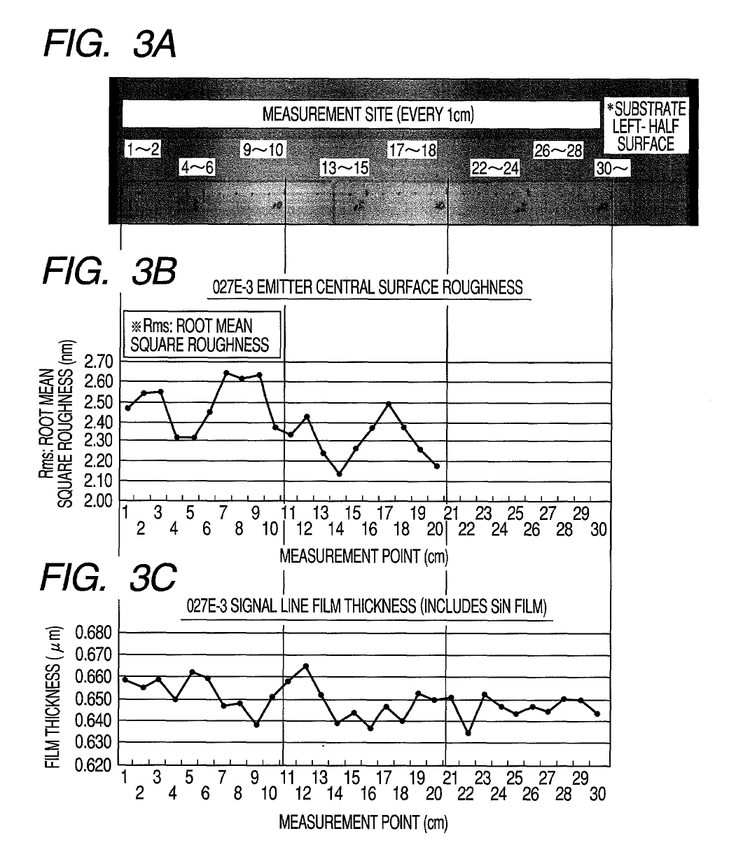

FIG. 3 is a diagram, explaining embodiment 2 of the invention, showing a front surface lit display photo (a) of the display surface of the cathode substrate, the measurement results (b) using AFM of the surface roughness distribution of the tunnel part, and measured results of the same distribution using a probing-type step meter. Here, the manufactured cathode array (emitter array) substrate is juxtaposed with the glass substrate that has coated on its entire surface green phosphor, performing an entire surface lighting experiment in a vacuum vessel.

From the photo of FIG. 3(A), it is possible to determine the vertical striped film (4 dark pieces, approximately 90 mm period). Portions of the substrate are cut, with measurements taken of the surface roughness by AFM for the tunnel insulation film (emitter region) and of the winding thickness by the probing type step meter. The results indicated that in contrast to the correlation that was seen between the previously described brightness and darkness and the surface roughness (root-mean roughness), no correlation was observed for film thickness.

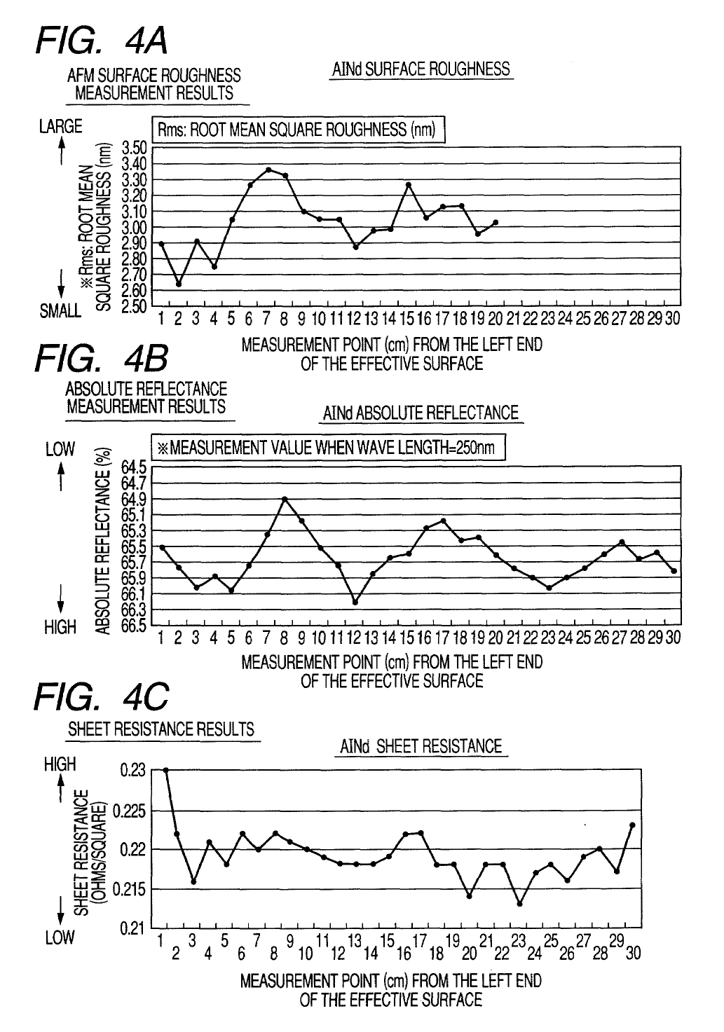

FIG. 4 is a diagram which shows the measurement results (a) from AFM of the surface roughness distribution of the tunnel part of the Al—Nd film which was manufactured under the same conditions as the cathode substrate that was used in FIG. 3, the measurement results (b) of the distribution of the absolute reflectance of the same sites, and the measurement results (c) of the sheet resistance distribution at the same sites. According to these results, a correlation exists between surface roughness and absolute reflectance. On the other hand, no correlation was seen between surface roughness and sheet resistance.

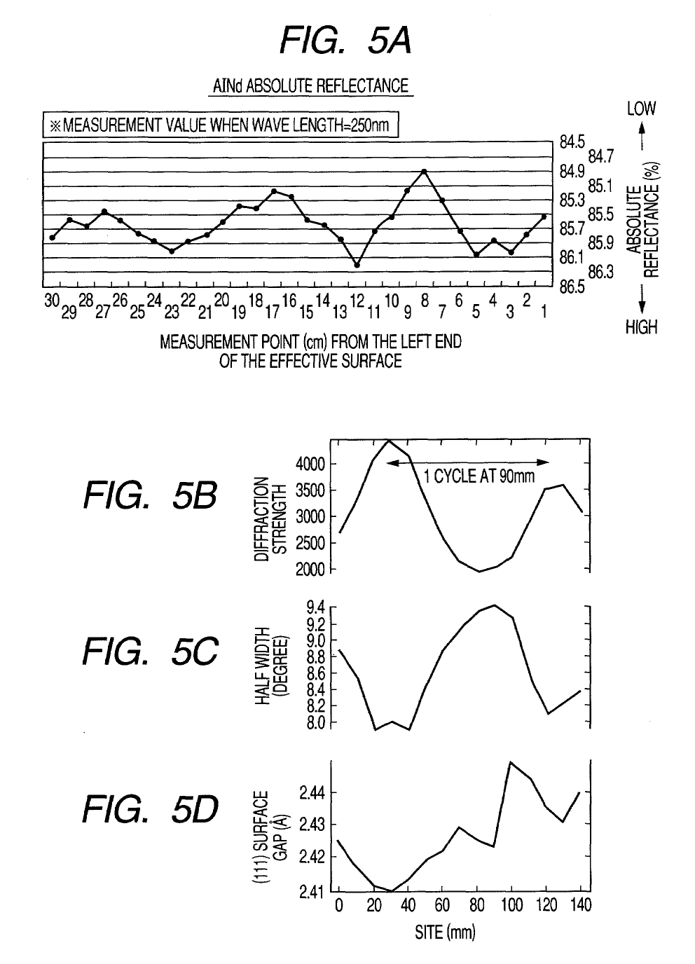

Next, by X-ray analysis, there was an evaluation done of the crystal nature of the AL alloy films. FIG. 5 is a diagram showing the measurement results (a) of the absolute reflectance of the Al—Nd film that was manufactured under the same conditions as the cathode substrate used in FIG. 3, and the measurement results of the diffraction strength (b), half-width (c), and surface gaps (d) obtained from of the rocking curve of the (111) diffraction peak using the same sites as the measurement sites of (a). Because changes of period equal to those of the vertical strips were observed for the diffraction strength and half-width, it was determined to adjust the orientation by magnet action at a distance.

The maximum point of diffraction strength (half-width maximum) corresponds to the minimum point of absolute reflectance=minimum point of surface roughness, that is, to the dark point of the brightness distribution. This point represents a match with the results indicating that for the (111) oriented film used in embodiment 1, current leakage is difficult (threshold shifts to the right).

From these measurements, when using the (111) oriented film, if there is no control of the orientation distribution so that using at a minimum the strength ratios, (Imax−Imin)/(Imax+Imin)=39.0% or less, or using the half-width ratios, (Wmax−Wmin)/(Wmax+Wmin)=8.8% or less, it is determined that uniformity of brightness 10% or less cannot be obtained.

In this case, as a countermeasure, a (111) 2% oriented film is obtained using half-width ratios when stopping the action at a distance of the magnet and forming the film. Vertical stripes cannot be seen anymore.

Here, there is an explanation of the measurement method for X-ray diffraction which is disclosed by this embodiment. (1) Measurement conditions for wide-angle X-ray diffraction: use an X-ray diffraction device for measurements of the wide-angle X-ray diffraction with output of 50 kV, 250 mA with Cu as a target. Graphite that is positioned in front of a detector is used for spectroscopic crystals, taking measurements of only the Cu-k α-ray lines (wavelength: 15418 \acute{Å}). The detector uses a scintillation counter. The divergence slit right before the sample is at 0.5°, the scattering slit right after the sample is at 0.5°, and the light receiving slit right after the detector is assumed to be 0.3 mm. The measurements assume a θ-2θ scan, a continuous scan of 2°/min, in 0.05° steps, with the scanning range using 2θ of from 10-100°.

(2) Measurement conditions for the rocking curve of the diffraction line (111): measurements of the rocking curve used a thin film X-ray diffraction device. Cu was used as a target for the X-ray source, assuming outputs of 40 kV and 400 mA. A multi-layer film mirror was used placed directly under the light source, and measurements were only taken of the Cu-k α-rays (wavelength: 15418 \acute{Å}). The detector used a scintillation counter. The slit right before the sample was 0.2×10 mm, and the solar slit directly before the detector was assumed to be at 4°, limiting the divergence angle in the direction of a beam size of 10 mm. The detector was set at an angle (2θ) to the (111) diffraction line and scanning and measurements were done of an X-ray incident angle: θ towards the sample. The measurements were done with a 2°/min continuous scan, in 0.1° steps, following a scanning range of 0-38°.

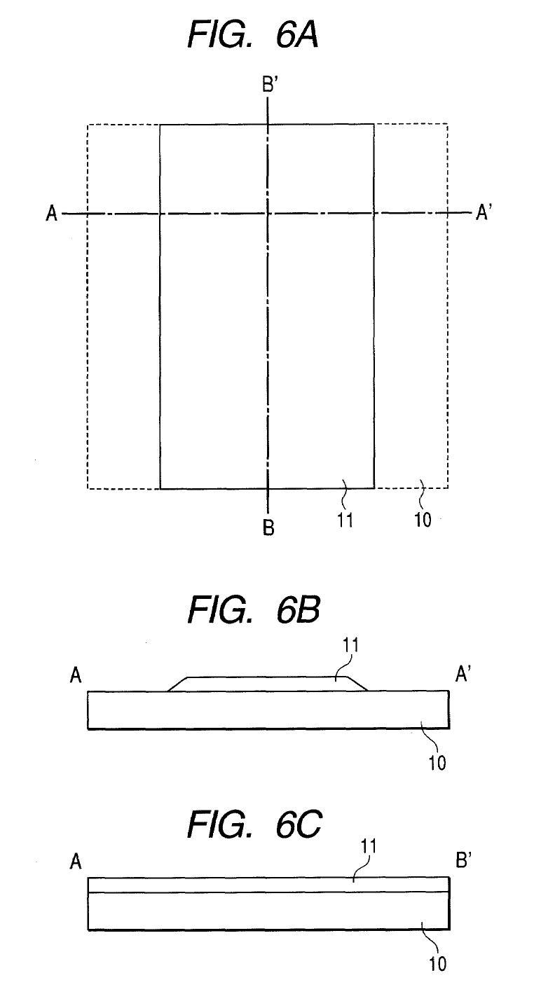

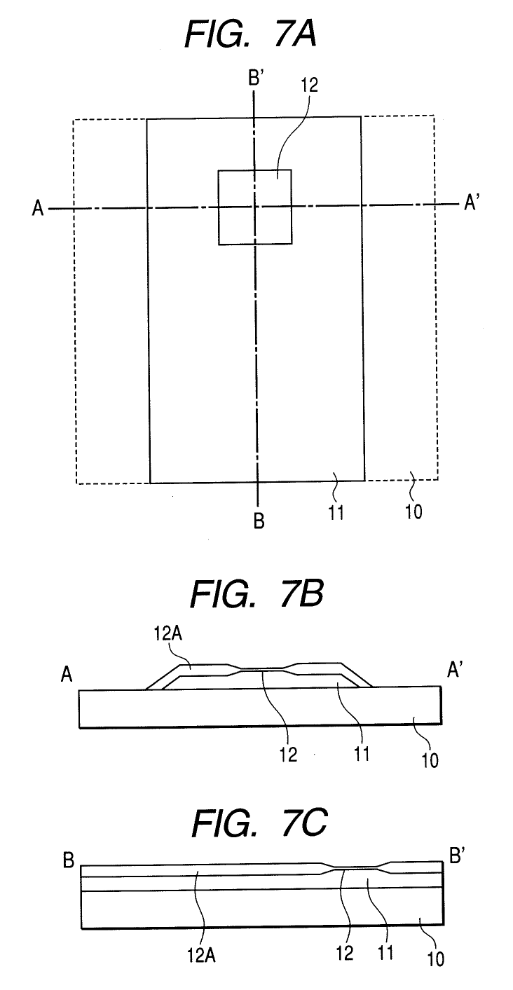

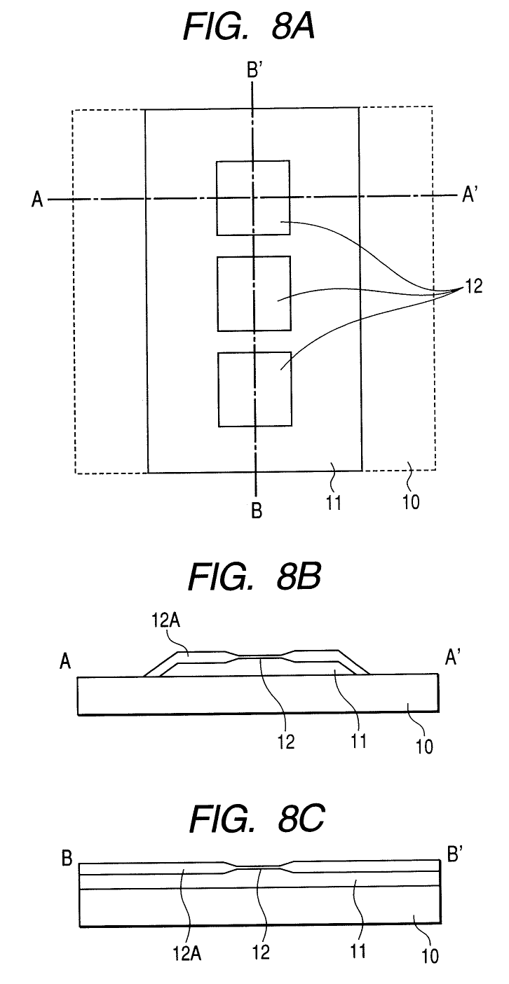

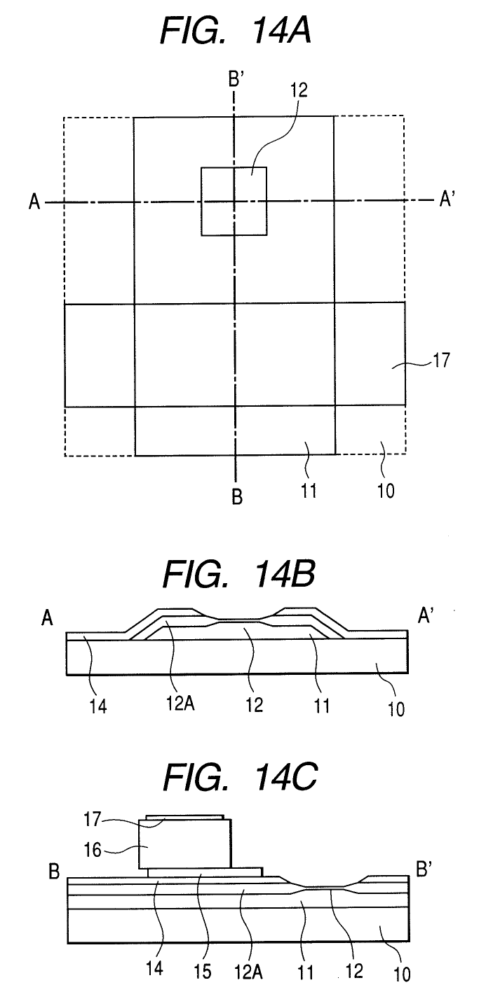

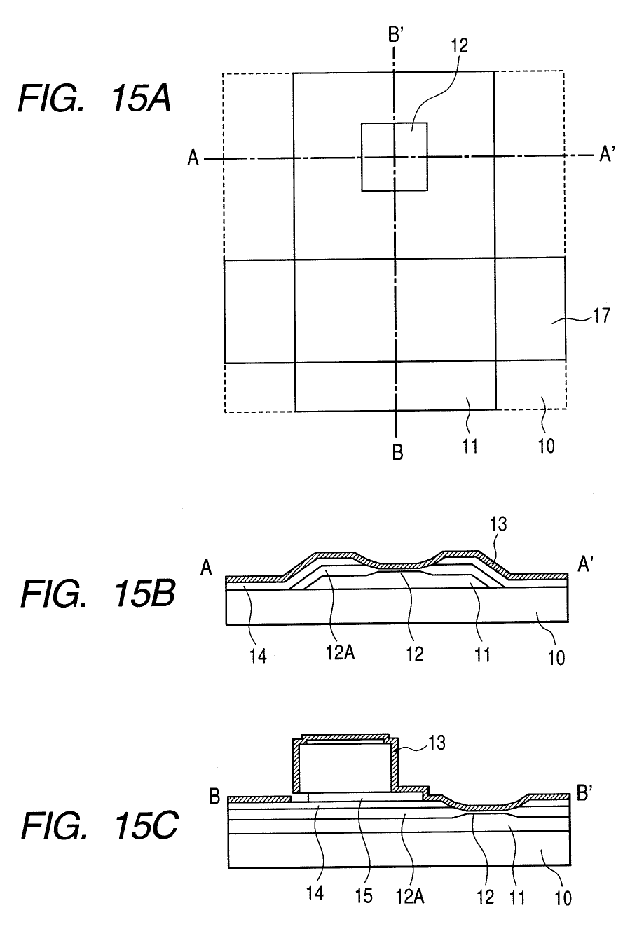

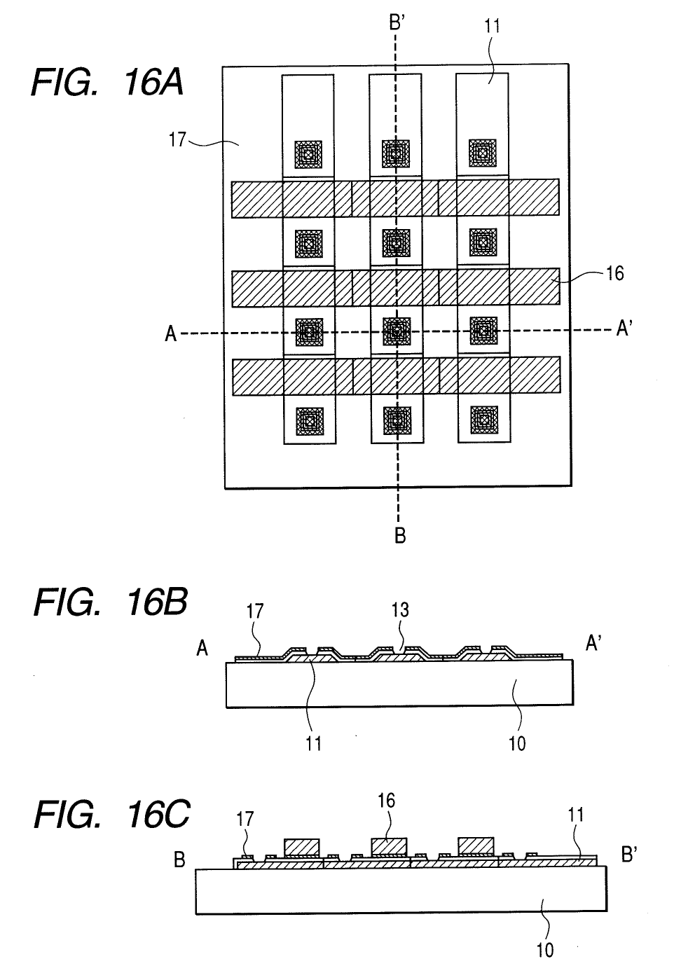

Next, according to FIGS. 15-16, there is an explanation of the process of manufacturing the electron source for the display apparatus that is appropriate for diode elements of this invention. FIG. 7 is a process diagram which continues from FIG. 6, FIG. 8 is a process diagram which continues from FIG. 7 . . . FIG. 15 is a process diagram which continues from FIG. 14. For each diagram, (a) denotes a flat surface diagram, (b) a cross-sectional view along the A-A′ line of (a), and (c) a cross-sectional view along the B-B′ line of (a).

In FIG. 6, there is formed a metal film which is used for the signal electrode 11 (hereafter, the lower electrode 11) on the substrate (called back surface substrate or cathode substrate) 10 with insulating properties such as glass. Materials that are used for the lower electrode 11 are aluminum or aluminum alloys. Here, there is used an Al—Nd alloy that has been doped 2% atomic weight with neodymium (Nd). The sputter method, for example, is used to form a metal film. The film thickness is assumed be 300 nm. After film formation, a stripe-shaped lower electrode is formed as shown in FIG. 6 by a photolithography process and an etching process. Etching liquid is used for wet etching using an aqueous solution mixture of phosphoric acid, acetic acid, and nitric acid.

In FIG. 7, there is imparted a resist pattern to one part of the lower electrode 11, anodizing the surface locally. Continuing, the resist pattern that was used for local oxidation is separated, once again anodizing is done for the lower electrode 11, forming an insulating layer (tunnel insulating film) from an electron acceleration layer on the lower electrode 11. A field insulating film 12A is formed around the tunnel insulating film 12. At this time, in the region where already the oxidized film has formed, without oxidation, an oxidized film forms only in the region that was covered by the resist by pre-processing.

FIG. 8 is an explanation diagram that is identical with FIG. 8 (?) for the terminal part of the signal line. In this invention, the insulating layer 12 is formed in plurality in the same way as the pixel parts at the terminal parts of the signal lines.

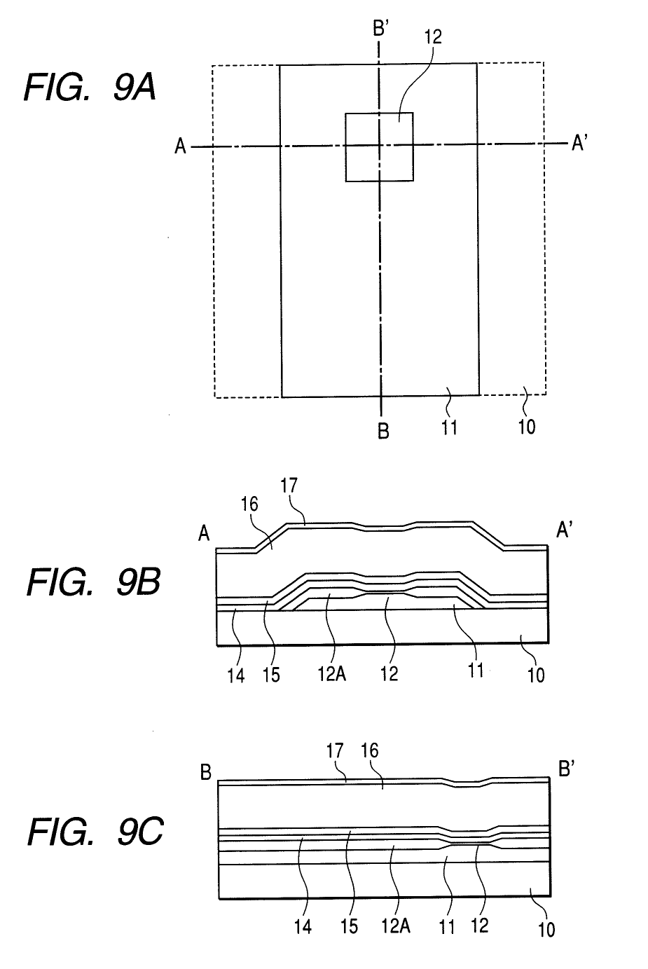

In FIG. 9, a silicon nitride element SiN (for example, Si₃N₄) is formed by the sputter method as insulation layer 14. There is formed the connection electrode 15 as 100 nm of chromium (Cr) and 2 μm of an Al alloy as the upper electrode power supply line (upper electrode power supply line and scan line bus interconnection), and on top of these layers a surface protection layer 17 made of Cr is placed.

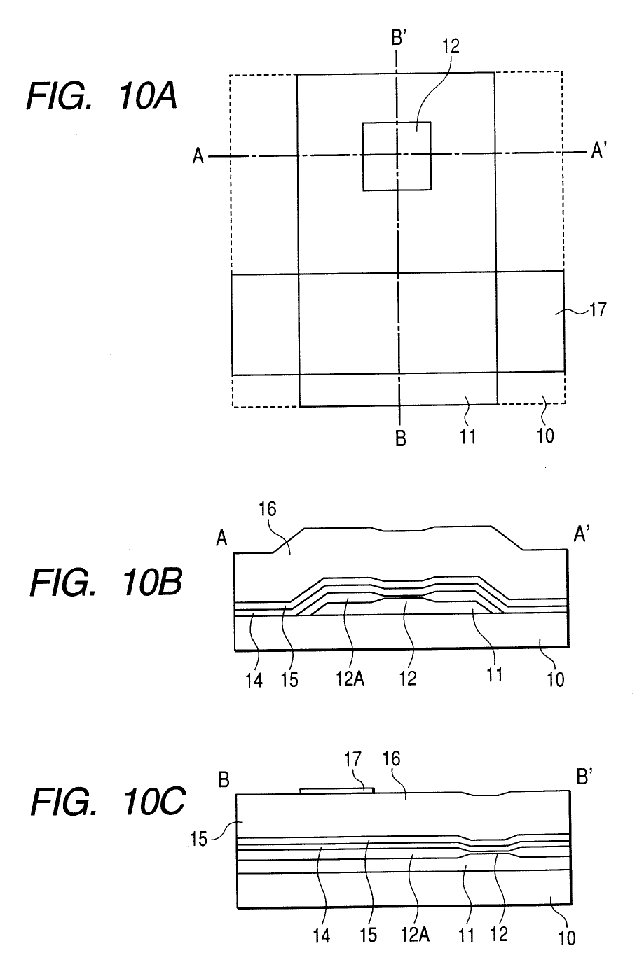

In FIG. 10 there remains the Cr of the surface protective layer on the part which became the scan line. An aqueous solution mixture of cerium nitrate 2-ammonium and nitric acid is appropriate for etching Cr. At this time, it is necessary to measure the line width of the surface protective layer 17 so as to make it narrowing than the line width of the upper electrode power supply line 16 which is manufactured by the following process. This is because the upper electrode power supply line 16 is composed of a 2 μm Al alloy, and because the generation of side etching to the same extent as wet etching can not be avoided. The strength of the part which extends on top of the cusp of the surface protective layer is not sufficient, easily crumbling during the manufacturing process or separates, and along with poor shots between the scan lines, there is induced lethal emissions because of the electric field concentration with high voltage applications.

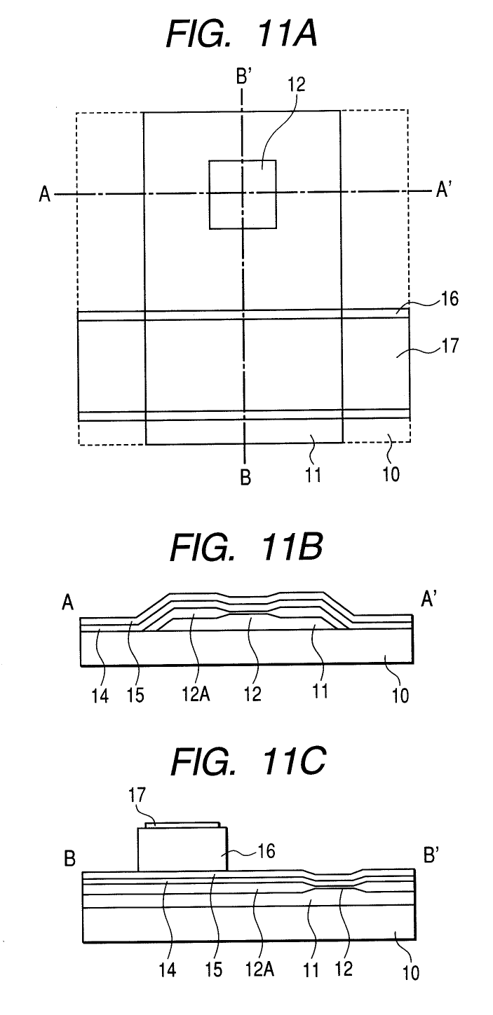

In FIG. 11, the lower electrode 11 is processed to a stripe-shape in a direction which intersects the upper electrode power supply line 16. It is appropriate to use an aqueous solution mixture of phosphoric acid, acetic acid, and nitric acid as the etching liquid.

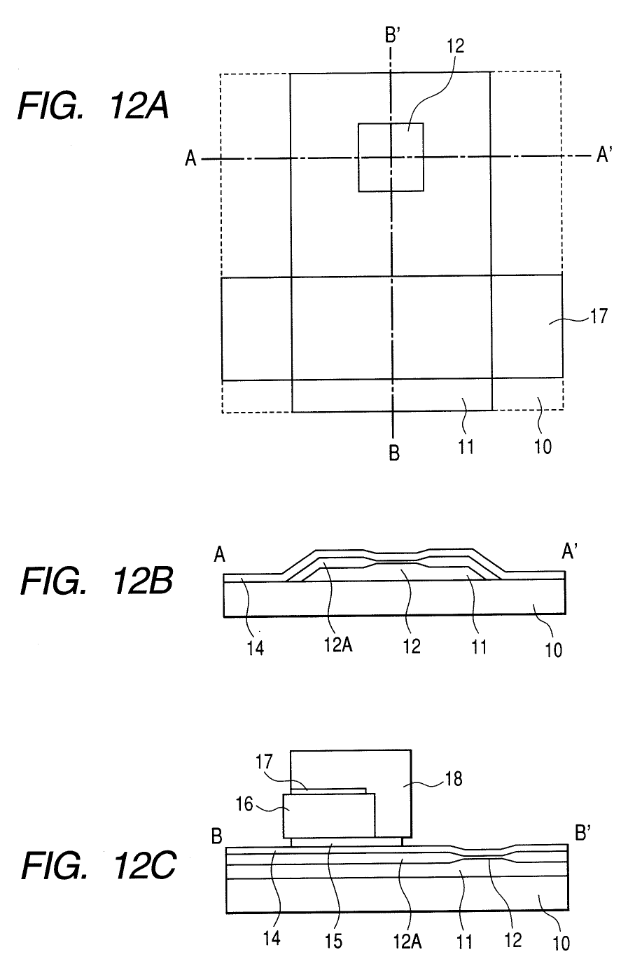

In FIG. 12, there is processing so that the connection electrode 15 is developed on the open side of the insulation film 14, and in addition, processing occurs (so as to be able to undercut) for retraction with respect to the upper electrode power supply line 16 at the opposite side. Accordingly, it is permissible to perform wafer etching by providing the photoresist pattern 18 on the connection electrode 15 using the first process and on the surface protective layer using the second process. The etching liquid can be the previously described cerium nitrate 2-ammonium and nitric acid. At this time, the insulating film lower layer 14 plays the role of etching stop which protects the tunnel insulation film 12 from the etching liquid.

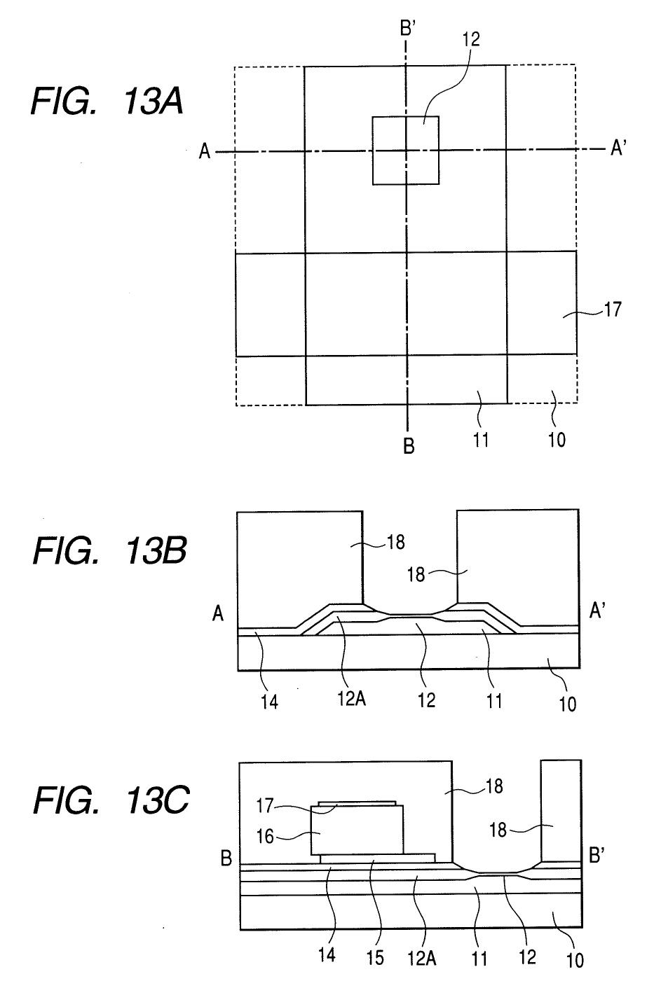

In FIG. 13, in order to open the electron emission part, there is opening of one part of the insulation film 14 by photolithography and dry etching forming resist pattern 18. A gas mixture of CF₄ and O₂ is appropriate for the etching gas. The exposed tunnel insulating film 12 executes once again anode oxidation, recovering processing damage by etching. As shown in FIG. 14, the resist pattern is eliminated.

As shown in FIG. 15, the cathode substrate (electron source substrate and cathode substrate) is completed by forming the upper electrode 13. Using a shadow mask for form the film of the upper electrode 13, a sputtering method is performed (sputter) so that no film is formed on the terminal part of the electrical interconnections which were placed on the substrate's periphery. The upper electrode power supply line 16 experiences (?) defects during the previously described undercutting manufacturing, and the upper electrode 13 automatically separates from each scanning line. Laminated films of Ir, Pt, and Au are used as materials for the upper electrode 13, with respective film thicknesses at several nm. From these considerations, it is possible to avoid contamination or damage to the upper electrode 13 or the tunnel insulation film 12 through etching.

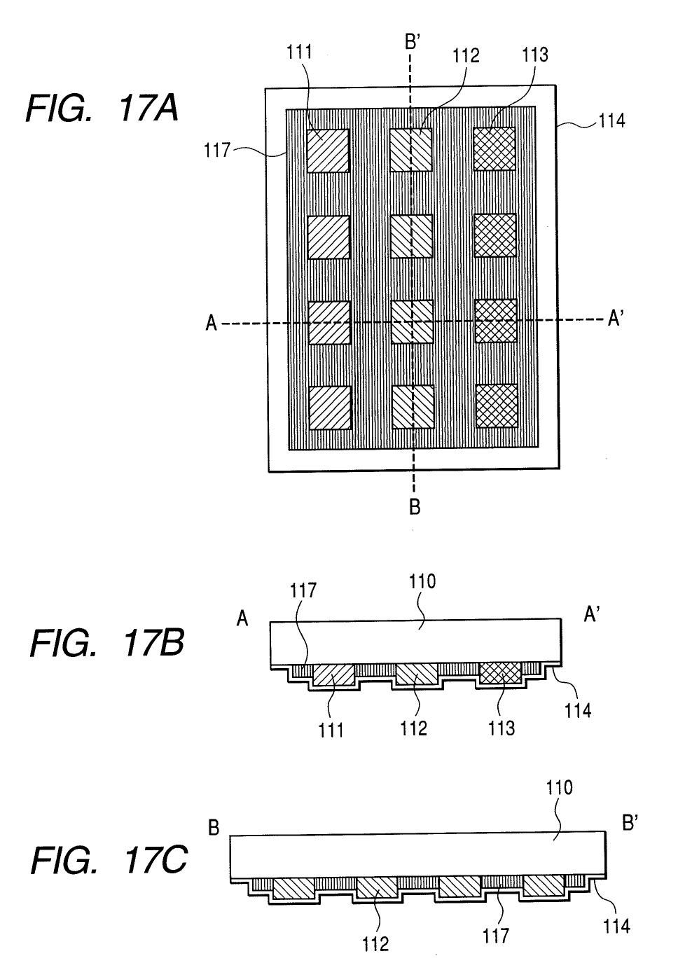

FIGS. 16 and 17 are used in an explanation of a construction example of an image display apparatus which uses MIM type cathode substrates. First, manufacture the cathode substrate by arranging a plurality of MIM type electron sources on top of the cathode substrate 10 by the previously described process. For explanation purposes, there are shown plan view and cross-sectional diagrams of the (3×4) dot MIM type electron source substrates, but actually, there is formed a matrix of several MIM type electron sources corresponding to the display dot count.

FIG. 16A is a plan view, 16(b) an A-A′ cross-sectional view of 16A, 16(c) is a B-B′ cross-sectional view of 16(a). The same symbols that were used in previous explanations correspond to identical functional parts.

There is an explanation using FIG. 17 of the formation of the front substrate (called anode substrate) using this manufacturing process. FIG. 17A is a plan view, FIG. 17B is an A-A′ cross-sectional view of FIG. 17(a), and FIG. 17(c) is a B-B′ cross-sectional view of 17(a). The same symbols that were used in previous explanations correspond to identical functional parts. The anode substrate 110 uses transparent glass and the like.

First, form a black matrix 117 with the goal of raising the contrast of the image display apparatus. For the black matrix 117, there is coating on the anode substrate of a liquid that has mixed PVA (polyvinyl alcohol) and ammonium bichromate and after exposing by irradiating ultraviolet rays on the outside parts in trying to form the black matrix 117, eliminate the already exposed portions. Further form by coating liquid from melted black lead powder and then lift off the PVA.

Next, form the red color phosphor 111. After coating on the anode substrate 110 an aqueous solution which has mixed PVA (polyvinyl alcohol) and ammonium bichromate with phosphor particles, and after exposing by irradiating ultraviolet rays on the portion which forms the phosphor, eliminate the exposed parts using liquid water. In this way, a pattern is made of red colored phosphor 111. In the same way, form a green color phosphor 112 and a blue color phosphor 113. It is permissible to use for the specific phosphors the following: for red color Y₂O₂S: Eu P22-R), for green color ZnS:Cu, Al (P22-G), and for the blue color, ZnS: Ag (P22-B).

Next, after planarizing the surface by filming using film such as nitrocellulose, perform an evaporation process of the Al to a film thickness of 75 nm on the anode electrode substrate 110, assuming metal back 114. This metal back 114 functions as an acceleration electrode. Afterwards, heat the anode substrate 110 in the atmosphere to 400° C., thermally decomposing the organic substances such the filming film or PVA. In this way, the anode substrate is completed. Through spacer 30 the anode substrate 110 and the cathode substrate 10 that were manufactured in this way are sealed using fritted glass 115 through interposition of the glass frame 116 on the periphery of the display region.

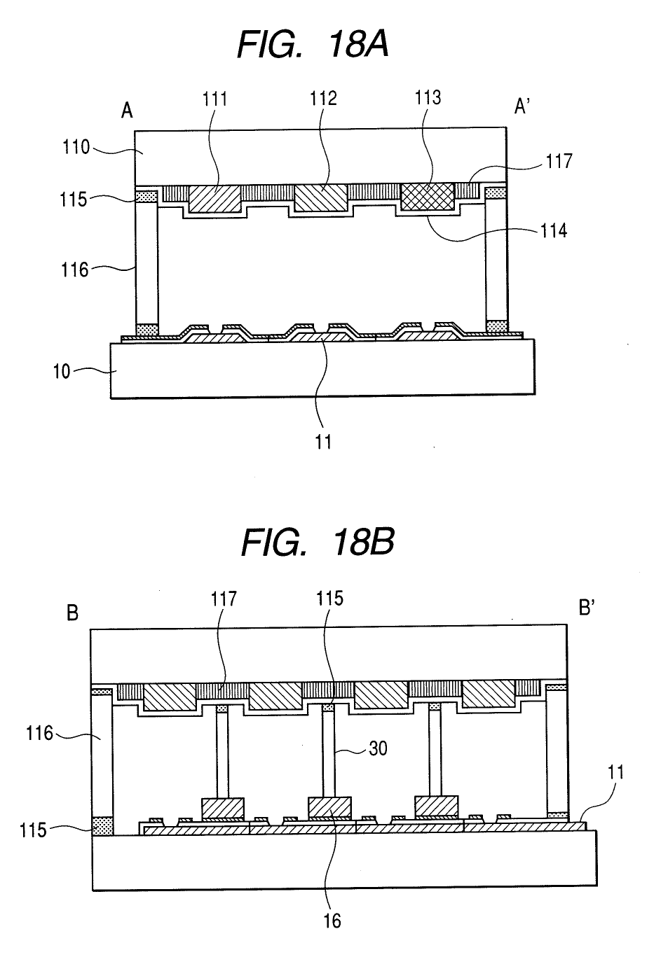

FIG. 18 is a cross-sectional view of the image display apparatus which has pasted together the cathode substrate and the anode substrate, with FIG. 18(a) corresponding to an A-A section of FIG. 17, and FIG. 18(b) corresponding to the B-B′ section of FIG. 17. There is established a height for the spacer 30 of 1-3 mm as the distance between the pasted anode substrate 110 and the cathode substrate 10. The spacer 30 positions on top of the upper electrode power supply line 16 plate-shaped glass or ceramics. In this case, because the spacer is positioned under the black matrix 117 on the display substrate side, the spacer doe not prevent the emission of light. Here, for explanation purposes, all of the spacers are set on top of every dot which emits light for R (red), G (green), and B (blue), that is, on top of the upper electrode power supply line 16, but actually, there is a reduction in the sheet count (density) for the spacer 30 at the boundary where mechanical strength endures. It is permissible that the separation be several cm.

In addition, there is no explanation, but it is possible to assemble the panels by the same method used for lattice-shaped spacers. The sealed panels are released by discharging to a vacuum of 10⁻⁷ Torr. After encapsulation, activate the housed getter, maintaining the inside of the vessel which was formed by the substrate and the rod at a high vacuum. For example, when the principal component of the getter is assumed to be Ba, it is possible to form a getter film from high frequency conduction heating. In addition, it is permissible to use, a non-evaporating type getter whose principal component is zinc. In this way, a display panel which uses MIM type electron sources is completed. Because the distance between the anode substrate 110 and the cathode substrate 10 is significant, on the order of 1-3 mm, it is possible to have an acceleration voltage applied to the metal back 114 as a high voltage in the range of 1-10 kV. It is thus possible to have phosphors that can be used with anode line tube (CRT).

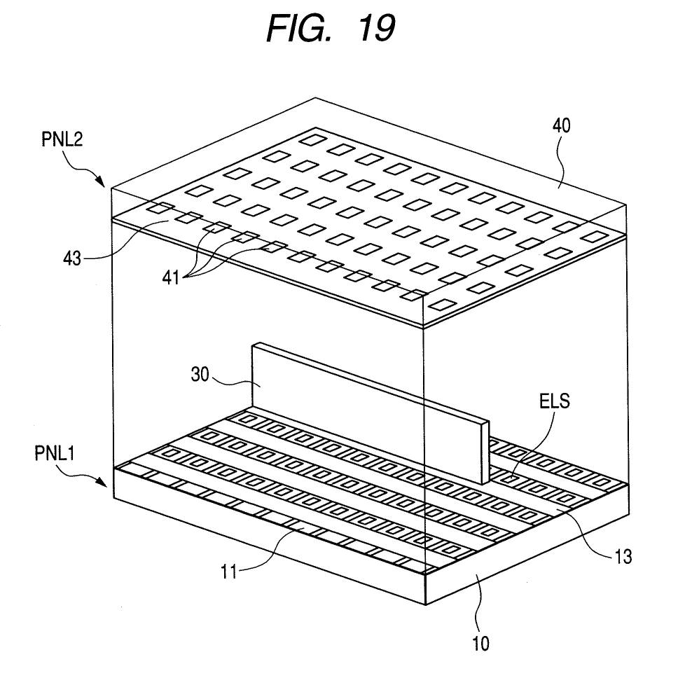

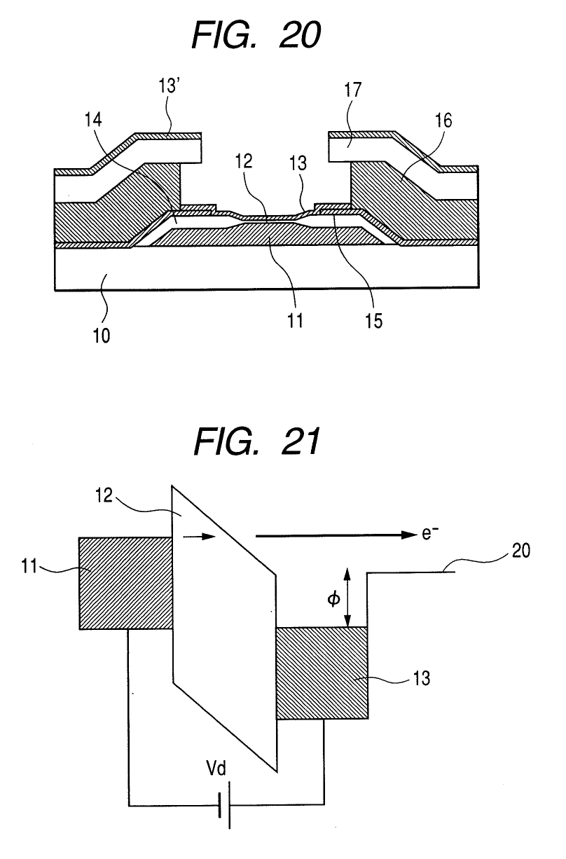

FIG. 19 is a development schematic diagram which explains a summary of all construction examples for this invention's image display apparatus. A back panel PNL1 which forms a cathode substrate, has, on the inner surface of this cathode substrate 10, an upper electrode 13 which is formed by a plurality of scan lines for which a scanning signal is successively applied in one direction and then in other parallel directions which intersect with said direction, and a plurality of signal lines 11 (lower electrode 11) which are established in parallel with one direction so that there is intersection with the upper electrode which is formed by the scan lines that exist in other directions and an electron source ELS which is established in the vicinity of every crossing of the upper electrode 13 and the lower electrode 11. The lower electrode 11 is formed on top of the anode substrate, and the upper electrode is formed by the interlayer insulating layers on top.

There is formed sub-pixels of 3 colors (red (R), green (G), and blue (B)) which are mutually partitioned using the black matrix 43 within the surface of the substrate 110 and an anode (anode) 43 on the front panel PNL 2 which forms the anode substrate. Using this construction example, there is interposed a glass frame, not illustrated, at a specified gap with pasting of both panels by establishing the spacer 30 along said scan line 13 and vacuum sealed. Only one sheet is shown for the spacer 30, but normally there is a division into a plurality of sheets on the upper electrode which forms one scan line, and in addition, a spacer is established for each of any number of upper electrodes.

What is claimed is:

1. A diode element of metal-insulating layer-metal type which is formed by stacking in order a lower electrode, insulating layer, and an upper electrode on a flat substrate,
wherein the insulating layer is composed of a non-crystalline oxidized layer which forms, using anodization, and
wherein the lower electrode, and the lower electrode is composed of a simple layer film of aluminum or aluminum alloy or a laminated layer film which has any one of these, and in the anodization process the aluminum or aluminum alloy film are non-crystalline.

2. A diode element of metal-insulating layer-metal type which is formed by stacking in order a lower electrode, insulating layer, and an upper electrode on a flat substrate,
wherein the insulating layer is composed of a non-crystalline oxidized layer which forms, using anodization, the lower electrode, and
wherein the lower electrode is composed of a simple layer film of aluminum or aluminum alloy or a laminated layer film which has an outermost layer of aluminum or aluminum alloy and in the anodization process, there are low oriented aluminum or aluminum alloy crystals with a ratio [(220) strength/(111) strength]] of peak strength of (220) diffraction lines and (110) peak strength of diffraction lines, given from wide-angle X-ray diffraction of the aluminum or aluminum alloy, is in the range of 0.2 to 0.6.

3. A diode element of metal-insulating layer-metal type which is formed by stacking in order a lower electrode insulating layer, and an upper electrode on a flat substrate,
wherein the insulating layer is composed of a non-crystalline oxidized layer which forms, using anodization, the lower electrode, and
wherein the lower electrode is composed of a simple layer film of aluminum or aluminum alloy or a laminated layer film which has an outermost layer of aluminum or aluminum alloy and when actually used, the aluminum or aluminum alloy films are crystals whose half-width distribution of the X-ray diffraction rocking curve for superior oriented crystal surfaces within the substrate is 10% or less.

4. A diode element according to claim 3,
wherein there is injection for the diode element with respect to the lower electrode to the insulating layer hot electrons by applying a positive bias to the upper electrode, forming a cold cathode electron source which releases towards the vacuum from the upper electrode one part of the injected hot electrons, and
wherein the upper electrode has a film thickness that is equal or lower when comparing to an average free process that is related to electron scattering within the electrode and in addition, the surface work function is smaller than the maximum energy of the hot electrons within said electrode.

5. A diode element according to claim 4,
wherein the upper electrode is a laminated film to which iridium, platinum and gold are laminated in this order.

6. A display panel comprising:
a flat first substrate which has provided on the inner surface a plurality of electron sources which are arranged in a matrix form; and
a flat second substrate which has a plurality of phosphor which respectively correspond with the electron sources,
wherein the electron sources are comprised of metal-insulating layer-metal which are formed by stacking in order a lower electrode which is formed on the first substrate, an insulating layer, and an upper electrode,
wherein the insulating layer is composed of a non-crystalline oxidized layer which forms, using anodization, the lower electrode, and
wherein the lower electrode is composed of a simple layer film of aluminum or aluminum alloy or a laminated layer film which has an outermost layer of aluminum or aluminum alloy and in the process of anodization, the aluminum or aluminum alloys in a display region are non-crystals.

7. A display panel comprising:
a flat first substrate which has provided on the inner surface a plurality of electron sources which are arranged in a matrix form; and
a flat second substrate which has a plurality of phosphor which respectively correspond with the electron sources,
wherein the electron sources are comprised of metal-insulating layer-metal which are formed by stacking in order a lower electrode which is formed on the first substrate, an insulating layer, and an upper electrode,
wherein the insulating layer is composed of a non-crystalline oxidized layer which forms, using anodization, the lower electrode, and
wherein the lower electrode is composed of a simple layer film of aluminum or aluminum alloy or a laminated layer film which has an outermost layer of aluminum or aluminum alloy and in the anodization process, there are low oriented aluminum or aluminum alloy crystals with a ratio [(220) strength/(111) strength]] of peak strength of (220) diffraction lines and (110) peak strength of diffraction lines, given from wide-angle X-ray diffraction of the aluminum or aluminum alloy in a display region, is in the range of 0.2 to 0.6.

8. A display panel comprising:
a flat first substrate which has provided on the inner surface a plurality of electron sources which are arranged in a matrix form; and
a flat second substrate which has a plurality of phosphor which respectively correspond with the electron sources,
wherein the electron sources are comprised of metal-insulating layer-metal which are formed by stacking in order a lower electrode which is formed on the first substrate, an insulating layer, and an upper electrode,
wherein the insulating layer is composed of a non-crystalline oxidized layer which forms, using anodization, the lower electrode, and
wherein the lower electrode is composed of a simple layer film of aluminum or aluminum alloy or a laminated layer film which has any one of these, and when actually used, the aluminum or aluminum alloy films in a display region are crystals whose half-width distribution of the X-ray diffraction rocking curve for superior oriented crystal surfaces, within the substrate is 10% or less.

9. A display device according to claim 8,
wherein there is injection for the diode element with respect to the lower electrode to the insulating layer hot electrons by applying a positive bias to the upper electrode, forming a cold cathode electron source which releases towards the vacuum from the upper electrode one part of the injected hot electrons, and
wherein the upper electrode has a film thickness that is equal or lower when comparing to an average free process that is related to electron scattering within the electrode and in addition, the surface work function is smaller than the maximum energy of the hot electrons within said electrode.

10. A display device according to claim 9 wherein the upper electrode is a laminated film to which iridium, platinum and gold are laminated in this order.
